(19) United States
(12) Patent Application Publication
(10) Pub. No.: US 2023/0387610 A1
(43) Pub. Date: Nov. 30, 2023

(54) Terminal Body, Terminal, and Connector

(71) Applicants: Tyco Electronics Technology (SIP) Ltd., Suzhou (CN); Tyco Electronics (Shanghai) Co., Ltd., Shanghai (CN)

(72) Inventors: Weidong Zhang, Shanghai (CN); Wenzheng Ma, Suzhou (CN); Jian Wang, Suzhou (CN); Pengsheng Jiang, Suzhou (CN); Zaiyun Bai, Suzhou (CN)

(73) Assignees: Tyco Electronics Technology (SIP) Ltd., Suzhou (CN); Tyco Electronics (Shanghai) Co., Ltd., Shanghai (CN)

(21) Appl. No.: 18/201,554

(22) Filed: May 24, 2023

(30) Foreign Application Priority Data
May 24, 2022 (CN) 202221257268.X

(51) Int. Cl. H01R 4/18; H01R 13/42; H01R 13/15

(52) U.S. Cl. CPC H01R 4/184; H01R 13/42; H01R 13/15

(57) ABSTRACT

A terminal body includes a crimping part adapted to be crimped onto a cable, a mating part adapted to mate with a mating terminal, and a connecting part connected between the crimping part and the mating part. The crimping part includes a base connected to the connecting part and a pair of side wings extending from a pair of sides of the base beyond the connecting part. A stress relief notch is formed at a corner between each of the side wings and one of the connecting parts.

### CROSS-REFERENCE TO RELATED APPLICATION

This application claims the benefit of the filing date under 35 U.S.C. § 119(a)-(d) of Chinese Patent Application No. 202221257268.X, filed on May 24, 2022.

### FIELD OF THE INVENTION

The present invention relates to a terminal body, a terminal including the terminal body, and a connector including the terminal.

### BACKGROUND

In prior art, a high-voltage connector typically includes a housing and terminals installed in the housing. The terminal includes a terminal body, a pair of contacts installed in the mating part of the terminal body, and a locking member installed on the end of the mating part of the terminal body to lock the terminal in the housing. The pair of contacts are used for electrical contact with the mating terminal, and the crimping part of the terminal body is adapted to be crimped to a conductor core of a cable. In this way, the electrical connection between the cable and the mating terminal can be achieved through the terminals of the connector.

In prior art, the terminal body has a connecting part connected between the crimping part and the mating part. Usually, an arc shaped chamfer is formed at the corner between the side wing of the terminal body and the connecting part of the terminal body. However, in practical applications, it has been found that when crimping the side wing onto the cable, cracks appear at the corner between the side wing of the terminal body and the connecting part of the terminal body, and sometimes even lead to changes in the size of the insertion gap in the mating part of the terminal body, affecting the insertion of the mating terminal.

### SUMMARY

A terminal body includes a crimping part adapted to be crimped onto a cable, a mating part adapted to mate with a mating terminal, and a connecting part connected between the crimping part and the mating part. The crimping part includes a base connected to the connecting part and a pair of side wings extending from a pair of sides of the base beyond the connecting part. A stress relief notch is formed at a corner between each of the side wings and one of the connecting parts.

### BRIEF DESCRIPTION OF THE DRAWINGS

Features of the present invention will become more apparent by describing in detail exemplary embodiments thereof with reference to the accompanying drawings, in which:

FIG. 1 is a perspective view of a terminal according to an embodiment;

FIG. 2 is an exploded perspective view of the terminal;

FIG. 3 is a perspective view of a terminal body of the terminal;

FIG. 4 is a sectional side view of the terminal body; and

FIG. 5 is another sectional side view of the terminal body.

### DETAILED DESCRIPTION OF EXEMPLARY EMBODIMENTS

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

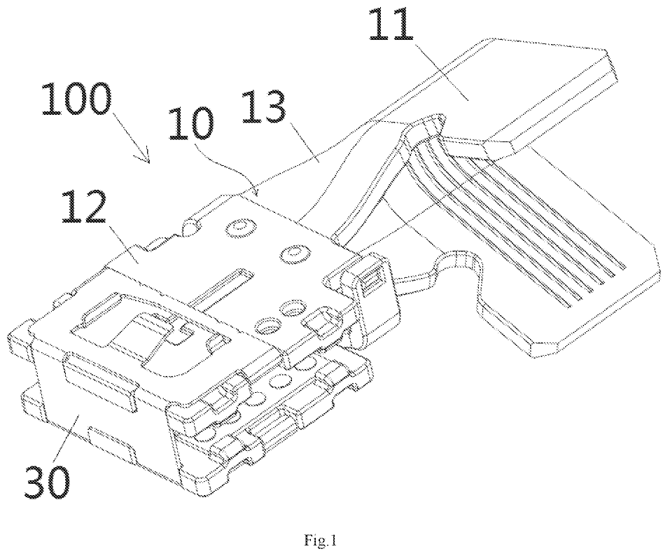

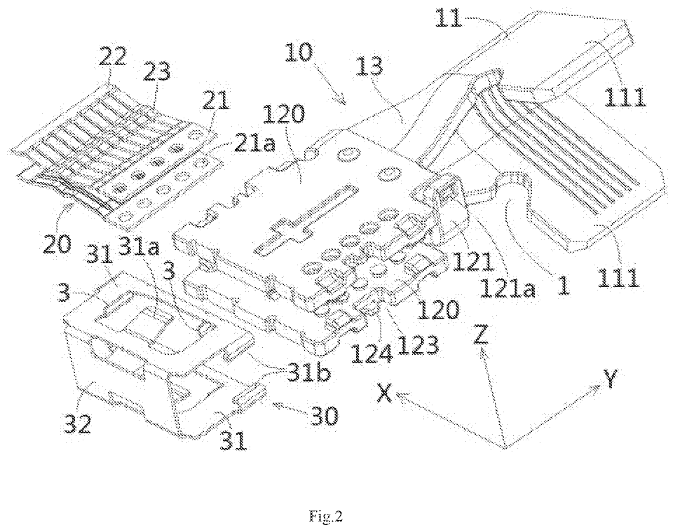

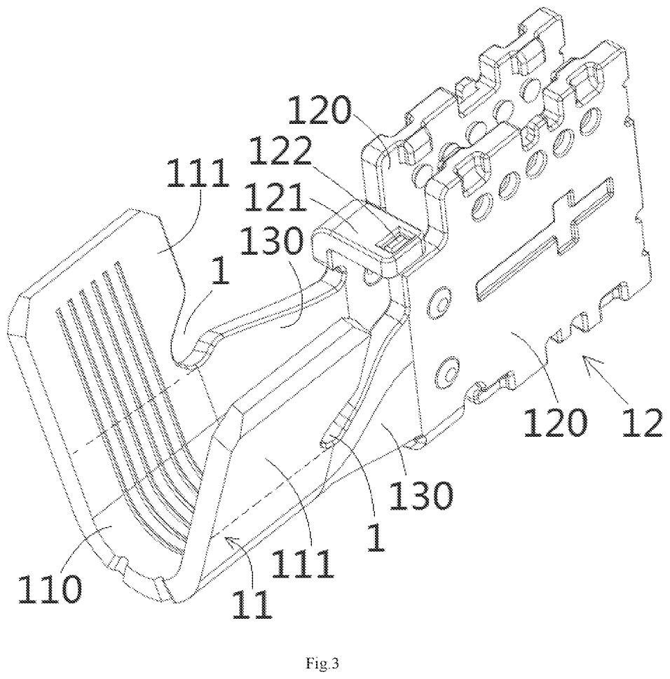

FIG. 1 shows an illustrative perspective assembly view of a terminal 100 according to an exemplary embodiment of the present invention. FIG. 2 shows an illustrative perspective exploded view of a terminal 100 according to an exemplary embodiment of the present invention. FIG. 3 shows an illustrative perspective view of a terminal body 10 of a terminal 100 according to an exemplary embodiment of the present invention.

The terminal 100 includes a terminal body 10, a pair of contacts 20 installed inside the terminal body 10, and a locking member 30 installed on the end of the terminal body 10.

As shown in FIGS. 1 to 3, in the illustrated embodiment, the terminal body 10 includes a crimping part 11, a mating part 12, and a connecting part 13. The crimping part 11 is adapted to be crimped onto a conductor core of a cable. The mating part 12 is suitable for mating with a mating terminal. The connecting part 13 is connected between the crimping part 11 and the mating part 12.

As shown in FIGS. 2 and 3, the crimping part 11 of the terminal body 10 includes a base 110 and a pair of side wings 111. The base 110 is connected to the connecting part 13. In the illustrated embodiment, the base 110 is U-shaped. The pair of side wings 111 extend upwards from both sides of the opening of the base 110 beyond the connecting part 13.

As shown in FIGS. 1 to 3, in the illustrated embodiments, a stress relief notch 1 is formed at the corner between the side wing 111 and the connecting part 13 to prevent local stress concentration.

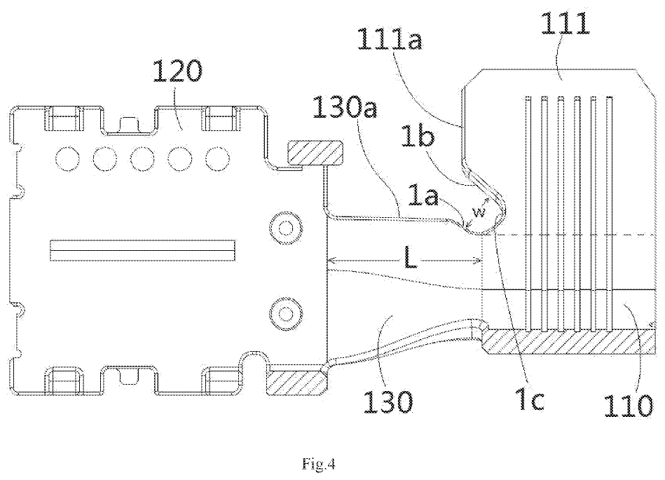

FIG. 4 shows a cross-sectional view of a terminal body 10 of a terminal 100 according to an exemplary embodiment of the present invention, indicating the width of stress relief notch 1.

The stress relief notch 1 is U-shaped, and the opening width W of the U-shaped stress relief notch 1, as shown in FIG. 4, is 10% to 50% of the longitudinal extension length L of the connecting part 13 in the longitudinal direction Y of the terminal body 10. For example, the opening width W of stress relief notch 1 can be equal to 10%, 20%, 30%, 40%, or 50% of the longitudinal extension length L of the connecting part 13. In the present invention, the opening width W of stress relief notch 1 must reach a certain size to fully release local stress.

As shown in FIG. 4, the side wing 111 has a front side edge 111a and a rear side edge that are opposite to each other in the longitudinal direction Y of the terminal body 10. The connecting part 13 has a pair of connecting side parts 130 connected to both sides of the front end of the base 110. The connecting side part 130 has an upper side edge 130a adjacent to the front side edge 111a of the side wing 111. The stress relief notch 1 is formed at the corner between the front side edge 111a of the side wing 111 and the upper side edge 130a of the connecting side part 130. In the illustrated embodiment, the front side edge 111a of the side wing 111 and the upper side edge 130a of the connecting side part 130 are approximately perpendicular.

The stress relief notch 1, as shown in FIG. 4, has a first side edge 1a, a second side edge 1b and a curved bottom edge 1c. The first side edge 1a is connected to the upper side edge 130a of the connecting side part 130. The second side edge 1b is parallel to the first side edge 1a and connected to the front side edge 111a of the side wing 111. The curved bottom edge 1c is connected between the first side edge 1a and the second side edge 1b. The first side edge 1a of the stress relief notch 1 extends diagonally downwards from the upper side edge 130a of the connecting side part 130 towards the base 110 of the crimping part 11. The second side edge 1b of the stress relief notch 1 extends diagonally downwards from the front side edge 111a of the side wing 111 towards the base 110 of the crimping part 11.

An angle between the first side edge 1a of the stress relief notch 1 and the upper side edge 130a of the connecting side part 130 is greater than zero degrees and less than 45 degrees. For example, the angle between the first side edge 1a of the stress relief notch 1 and the upper side edge 130a of the connecting side part 130 can be equal to 5 degrees, 10 degrees, 15 degrees, degrees, or other suitable angles.

Similarly, the angle between the second side edge 1b of the stress relief notch 1 and the front side edge 111a of the side wing 111 is greater than zero degrees and less than 45 degrees. For example, the angle between the second side edge 1b of the stress relief notch 1 and the front side edge 111a of the side wing 111 can be equal to 5 degrees, 10 degrees, 15 degrees, 20 degrees, or other suitable angles.

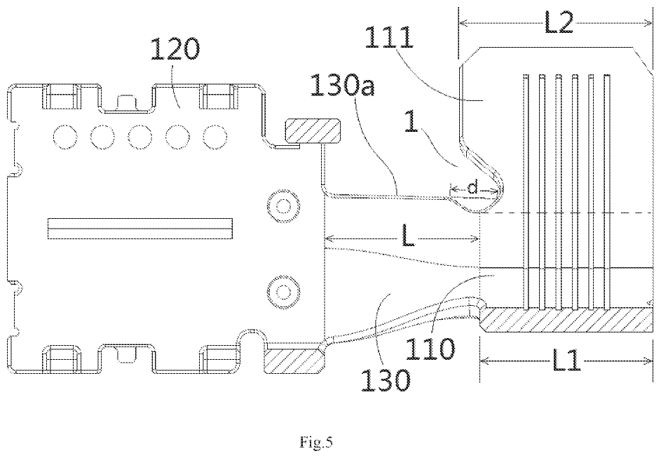

FIG. 5 shows a cross-sectional view of the terminal body 10 of terminal 100 according to an exemplary embodiment of the present invention, indicating the extension length of the side wing 111 of the terminal body 10.

The upper side edge 130a of the connecting side part 130 will intersect with the arc-shaped bottom 1c if the upper side edge 130a extends a predetermined length d, shown in Figure towards the stress relief notch 1 (i.e. the length of the extended line segment represented by the dashed line in FIG. 5), and the predetermined length d is not less than the width W of the stress relief notch 1. This predetermined length d is related to the depth of U-shaped stress relief notch 1. In the illustrated embodiment, the stress relief notch 1 should have a certain depth to fully release local stress.

As shown in FIG. 2, the mating part 12 of the terminal body 10 includes a pair of parallel installation plates 120. The rear side edges of the pair of installation plates 120 are connected to both sides of the front end of the base 110 through the connecting part 13. The surface of the installation plate 120 is parallel to the longitudinal direction Y of the terminal body and the pair of installation plates 120 is spaced at a predetermined distance in the direction Z perpendicular to its surface to allow the mating terminal to be inserted between the pair of installation plates 120.

As shown in FIGS. 2 and 3, connecting structures 121 and 122 are formed on the upper and lower sides of the pair of installation plates 120 near their rear side edges, respectively. The connection structures 121 and 122 are connected between the pair of installation plates 120 to ensure that the spacing between the pair of installation plates 120 is equal to a predetermined distance. A connecting arm 121 is formed on one of the upper and lower sides near the rear side of the installation plate 120, and the connecting arm 121 is bent 90 degrees relative to the surface of the installation plate 120. A tongue part 122 is formed on the other of the upper and lower sides near the rear side of the installation plate 120.

As shown in FIG. 2, in the illustrated embodiments, an insertion hole 121a is formed at the end of the connecting arm 121, and the tongue part 122 on one installation plate 120 is inserted into the insertion hole 121a of the connecting arm 121 on the other installation plate 120. The aforementioned connection structures 121 and 122 include the connecting arm 121 and the tongue 122 formed on the pair of installation plates 120, respectively.

In an embodiment, the terminal body 10 is an integral stamping component formed by stamping a single metal sheet. This can reduce manufacturing costs.

As shown in FIG. 5, the extension length L1 of the base 110 in the longitudinal direction Y of the terminal body 10 is smaller than the extension length L2 of the side wing 111 in the longitudinal direction Y of the terminal body 10, which can compensate for the local material removed by the formation of stress relief notch 1 to ensure that the contact area between the side wing 111 and the cable remains unchanged or increases.

As shown in FIG. 5, in the illustrated embodiment, the rear side edge of the side wing 111 and the end face of the rear end of the base 110 are in the same plane perpendicular to the longitudinal direction Y of the terminal body 10. The side wing 111 extends forward beyond the front end of the base 110 in the longitudinal direction Y of the terminal body 10.

A pair of contacts 20 of terminal 100, shown in FIG. 2, are respectively installed on the inner faces facing each other of the pair of installation plates 120 of terminal body 10. The pair of contacts 20 are used for electrical contact with the mating terminal inserted between the pair of contacts 20. The contact 20 includes two longitudinal edge parts 21 and 22 and a plurality of elastic arms 23. The two longitudinal edge parts 21 and 22 are parallel to each other and extend along the longitudinal direction Y of the terminal body 10. The plurality of elastic arms 23 are connected between two longitudinal edge parts 21 and 22 and evenly spaced along the longitudinal direction Y of the terminal body 10.

In the illustrated embodiments, one of the two longitudinal edge parts 21 and 22 of the contact 20 is fixed to the inner surface of the installation plate 120, and the other is movably supported on the inner surface of the installation plate 120. In the illustrated embodiment, one longitudinal edge part 21 of the contact 20 is riveted to the installation plate 120. For example, in the illustrated embodiment, a riveting hole 21a is formed on one longitudinal edge part 21 of the contact 20, which is riveted to the installation plate 120.

The locking member 30 of terminal 100, as shown in FIG. 1, is sleeved on the front end of the pair of installation plates 120 of terminal body 10, used to lock the terminal in a housing of a connector. As shown in FIG. 2, the locking member 30 includes: a pair of side plates 31 which are respectively installed on the outer sides of the pair of installation plates 120; and an end plate 32 which is connected between the front ends of the pair of side plates 31 and rests against the front end faces of the pair of installation plates 120. A locking spring 31a is formed on the side plate 31 adapted to be locked into a recess formed on an inner wall of the housing of the connector.

As shown in FIG. 2, a guide rib 3 suitable for mating with a guide groove on the inner wall of the housing of the connector is formed on the side plate 31 of the locking member 30, which is used to guide the terminal to be inserted into the housing of the connector. In the illustrated embodiment, two guide ribs 3 are formed on the side plate 31 of the locking member and the lengths of the two guide ribs 3 are different in the longitudinal direction Y of the terminal body 10. Two guide ribs 3 are separated in a direction X perpendicular to the longitudinal direction Y of the terminal body 10 and parallel to the installation plate 120. This can prevent the terminal from being inserted into the housing of the connector in a wrong orientation.

The side plate 31 of the locking member 30 has left and right sides opposite in the direction X perpendicular to the longitudinal direction Y of the terminal body 10 and parallel to the installation plate 120. Elastic clips 31b with a cross-section of C are formed on the left and right sides of the side plate 31, respectively, as shown in FIG. 2. A positioning groove 123 and a protrusion 124 located in the positioning groove 123 are formed on the left and right sides of the installation plate 120, respectively. The elastic clip 31b on the side plate 31 is positioned in the positioning groove 123 and clamps the protrusion 124.

In an exemplary embodiment of the present invention, a connector is also disclosed, which includes a housing and the aforementioned terminal 100. A terminal slot is formed in the housing. The terminal 100 is inserted into the terminal slot of the housing.

In the aforementioned exemplary embodiments according to the present invention, by forming a stress relief notch at the corner between the side wing and the connecting part of the terminal body, the stress concentration at the corner between the side wing and the connecting part of the terminal body can be fully eliminated, which ensures that the terminal body will not produce cracks when crimping the side wing to the cable, does not cause deformation of the mating part of the terminal body, and ensures that the size of the insertion gap in the mating part is not affected.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

What is claimed is:

1. A terminal body, comprising:
a crimping part adapted to be crimped onto a cable;
a mating part adapted to mate with a mating terminal; and
a connecting part connected between the crimping part and the mating part, the crimping part includes a base connected to the connecting part and a pair of side wings extending from a pair of sides of the base beyond the connecting part, a stress relief notch is formed at a corner between each of the side wings and one of the connecting parts.

2. The terminal body according to claim 1, wherein each of the side wings has a front side edge and a rear side edge which are opposite to each other in a longitudinal direction of the terminal body, the connecting part has a pair of connecting side parts respectively connected to both sides of a front end of the base, each connecting side part has an upper side edge adjacent to the front side edge of one of the side wings.

3. The terminal body according to claim 2, wherein the stress relief notch is formed at a corner between the front side edge of the side wing and the upper side edge of the connecting side part.

4. The terminal body according to claim 3, wherein the stress relief notch includes:
a first side edge connected to the upper side edge of the connecting side part;
a second side edge parallel to the first side edge and connected to the front side edge of the side wing; and
a curved bottom edge connected between the first side edge and the second side edge.

5. The terminal body according to claim 4, wherein the first side edge extends diagonally downwards from the upper side edge of the connecting side part towards the base of the crimping part, the second side edge extends diagonally downwards from the front side edge of the side wing towards the base of the crimping part.

6. The terminal body according to claim 5, wherein:
an angle between the first side edge and the upper side edge of the connecting side part is greater than zero degrees and less than 45 degrees; and/or
an angle between the second side edge and the front side edge of the side wing is greater than zero degrees and less than 45 degrees.

7. The terminal body according to claim 5, wherein the upper side edge of the connecting side part intersects with the curved bottom edge after extending a predetermined length towards the stress relief notch, the predetermined length is not less than a width of the stress relief notch.

8. The terminal body according to claim 3, wherein the mating part includes a pair of parallel installation plates, and a pair of rear side edges of the pair of installation plates are connected to both sides of the front end of the base through the connecting part, a surface of each of the installation plates is parallel to the longitudinal direction of the terminal body, the pair of installation plates is separated by a predetermined distance in a direction perpendicular to the surface to allow the mating terminal to be inserted between the pair of installation plates.

9. The terminal body according to claim 8, wherein a connecting structure is formed on an upper side and a lower side near a rear side of the pair of installation plates, the connecting structure is connected between the pair of installation plates to ensure that a spacing between the pair of installation plates is equal to the predetermined distance.

10. The terminal body according to claim 9, wherein a connecting arm is formed on one of the upper and lower sides near the rear side of one of the installation plates, the connecting arm is bent 90 degrees relative to the surface of the installation plates, a tongue part is formed on the other of the upper and lower sides near the rear side of the installation plate.

11. The terminal body according to claim 10, wherein an insertion hole is formed on an end of the connecting arm, the tongue part on one of the installation plates is inserted into the insertion hole of the connecting arm on the other of the installation plates, the connecting structure includes the connecting arm and the tongue part.

12. The terminal body according to claim 1, wherein the terminal body is an integral stamping component formed by stamping a single metal sheet.

13. The terminal body according to claim 1, wherein the base is U-shaped.

14. The terminal body according to claim 1, wherein an extension length of the base in a longitudinal direction of the terminal body is smaller than an extension length of each of the side wings in the longitudinal direction of the terminal body.

15. The terminal body according to claim 14, wherein a rear side edge of each of the side wings and an end face of a rear end of the base are in a same plane perpendicular to the longitudinal direction of the terminal body, each of the side wings extends forward beyond a front end of the base in the longitudinal direction of the terminal body.

16. The terminal body according to claim 1, wherein the stress relief notch is U-shaped, an opening width of the U-shaped stress relief notch is 10% to 50% of a longitudinal extension length of the connecting part in a longitudinal direction of the terminal body.

17. The terminal body according to claim 16, wherein the opening width of the stress relief notch is equal to 10%, 20%, 30%, 40%, or 50% of the longitudinal extension length of the connecting part.

18. A terminal, comprising:
a terminal body including:
a crimping part adapted to be crimped onto a cable;
a mating part adapted to mate with a mating terminal; and
a connecting part connected between the crimping part and the mating part, the crimping part includes a base connected to the connecting part and a pair of side wings extending from a pair of sides of the base beyond the connecting part, a stress relief notch is formed at a corner between each of the side wings and one of the connecting parts; and
a pair of contacts respectively installed on a pair of inner faces of a pair of installation plates facing each other of the terminal body, the pair of contacts electrically contact the mating terminal inserted between the pair of contacts.

19. The terminal according to claim 18, further comprising a locking member sleeved on a front end of the pair of installation plates of the terminal body.

20. A connector, comprising:
a housing formed with a terminal slot; and
the terminal according to claim 16 inserted into the terminal slot of the housing.
